(19) United States
(12) Patent Application Publication
(10) Pub. No.: US 2023/0418941 A1
(43) Pub. Date: Dec. 28, 2023

(54) DEVICE FOR PROVIDING ANALYSIS CAPABILITY, METHOD FOR PROVIDING ANALYSIS CAPABILITY, AND PROGRAM FOR PROVIDING ANALYSIS CAPABILITY

(71) Applicant: NIPPON TELEGRAPH AND TELEPHONE CORPORATION, Tokyo (JP)

(72) Inventors: Toshinori USUI, Musashino-shi, Tokyo (JP); Tomonori IKUSE, Musashino-shi, Tokyo (JP); Yuhei KAWAKOYA, Musashino-shi, Tokyo (JP); Makoto IWAMURA, Musashino-shi, Tokyo (JP); Jun MIYOSHI, Musashino-shi, Tokyo (JP)

(73) Assignee: NIPPON TELEGRAPH AND TELEPHONE CORPORATION, Tokyo (JP)

(21) Appl. No.: 18/024,777

(22) PCT Filed: Oct. 14, 2020
(86) PCT No.: PCT/JP2020/038801

§ 371 Date: Mar. 6, 2023

(51) Int. Cl. G06F 21/56; G06F 21/52

(52) U.S. Cl. CPC G06F 21/566; G06F 2221/034; G06F 21/52

(57) ABSTRACT

The analysis function imparting device acquires a plurality of execution traces related to a branch instruction and memory access, by inputting a test script to a script engine and causing the script engine to execute the test script. The analysis function imparting device specifies a similar sequence on the basis of the plurality of execution traces and detects a function call included in the specified sequence as a candidate of a type conversion function. The analysis function imparting device detects a variable having an input/output relationship from a variable of a candidate argument and a return value of the type conversion function among the execution traces. The analysis function imparting device executes a taint analysis on the type variable function of the variable having an input/output relationship of the type conversion function, and detects a propagation leakage function indicating a type variable function.

### TECHNICAL FIELD

The present invention relates to an analysis function imparting device, an analysis function imparting method, and an analysis function imparting program.

### BACKGROUND ART

With the emergence of various forms of attacks such as spam using malware (malware spam) and fileless malware, the threat of attacks by scripts that show malicious behavior (malignant scripts) has become apparent.

A malicious script is a script that has malicious behavior, and is a program that exploits the functions provided by the script engine to implement an attack. Generally, attacks are carried out, using a script engine provided by an operating system (OS) by default, or a script engine provided by a specific application such as a Web browser or document file viewer.

Although many such script engines require user permission in some cases, behavior through the system can also be realized, such as file operation, network communication, activation of processes, and so forth. Accordingly, attacks using malicious scripts are a threat to users in the same way as attacks using execution file malware.

In order to take countermeasures against attacks by malicious scripts, it is necessary to accurately understand the behavior of the script. Accordingly, there is a need for a technique of clarifying the behavior by analyzing the script.

A problem in analyzing malicious script is obfuscation of the code. Many malicious scripts have been subjected to processing called obfuscation, in order to interfere with analysis. Obfuscation makes analysis of code based on superficial information difficult, by intentionally increasing the complexity of the code. That is to say, obfuscation interferes with an analysis technique called static analysis, in which information acquired from the code is used for analysis, without executing the script.

Particularly, in a case of dynamically acquiring part of the code to execute from an external source, this code cannot be acquired without being executed, and accordingly cannot be statically analyzed. Thus, static analysis is impossible in principle.

Conversely, a technique called dynamic analysis where a script is executed and how the script behaves is monitored, thereby finding the behavior thereof, is not affected by the aforementioned obfuscation. Accordingly, techniques based on dynamic analysis are primarily used in analysis of a malicious script.

Most of the existing analysis techniques related to dynamic analysis analyse the behavior by following a flow of control (control flow) in the execution of the script. However, for more detailed behavior analysis, not only the analysis of the control flow but also analysis of flow of data (data flow) is also required.

If the data flow handled by the malicious script can be traced precisely, the analyst can grasp the attributes of the data (for example, whether it is a decryption key or a command from an attacker). This makes it possible to clarify the behavior of the malignant script in more detail.

There is a taint analysis as a method for realizing such data tracking. The taint analysis is a technique for analyzing the data flow, by adding attribute information called taint tags (hereinafter referred to as tags) to data and propagating it in accordance with the movement of data.

Regarding the realization of taint analysis for scripts, for example, in NPL 1, a propagation rule of tag is implemented for a virtual machine (VM) of Zend framework of PHP to realize taint analysis. According to this method, the data flow of the script of the PHP can be analyzed.

In NTL 2, propagation rules are implemented for VM of JavaScript to realize taint analysis. According to this method, the data flow of a JavaScript script can be analyzed.

In NPL 3, a technique for realizing a taint analysis using an abstract machine instead of the VM of JavaScript is described. According to this method, data flow analysis can be realized for scripts of JavaScript in various execution environments without depending on a specific VM.

NPL 4 discloses a technique for realizing the taint analysis by directly entering a propagation rule for propagating the tag of the left side value of each line of the script to the right side value into the script. According to this technique, data flow analysis can be realized regardless of the type of script language.

### CITATION LIST

### Non Patent Literature

[NPL 1] Monga et al. (2009) A hybrid analysis framework for detecting web application vulnerability.

[NPL 2] Vogt et al. (2007) Cross-Site Scripting Prevention with Dynamic Data Tainting and Static Analysis.

[NPL 3] Karim et al. (2018) Platform-Independent Dynamic Taint Analysis for JavaScript.

[NPL 4] Xu et al. (2005) Practical Dynamic Taint Analysis for Countering Input Validation Attacks on Web Applications.

### SUMMARY OF INVENTION

### Technical Problem

However, the above-described related art has a problem that it is not possible to realize fine particle size taint analysis for various script engines.

For example, the techniques described in NPL 1 and NPL 2 have a problem in that separate taint analysis functions need to be designed and implemented for each script engine. Further, in order to realize the tint analysis function, there was a problem that it was necessary to know information of the internal implementation of the virtual machine of the script engine in advance.

In the technique described in the NPL 3, JavaScript does not depend on a specific script engine, but also depends on a specific script language called JavaScript.

In the technique described in NPL 4, since it is difficult to cope with an obfuscated script since it is necessary to inject a code into a script body, and the technique is an analysis of a coarse particle size only for propagating a tag of a right side value to a left side value, it is not suitable for analysis of a malignant script.

The present invention has been made in view of the above, and an object thereof is to provide a device capable of achieving the application of a minute particle-size taint analysis function that can also be applied to obfuscated malignant scripts, without requiring individual design and implementation for various script engines and script languages, and without prior internal implementation information.

### Solution to Problem

In order to solve and achieve the above-mentioned problem, an analysis function imparting device according to the present invention includes an execution trace acquisition unit which acquires a plurality of execution traces related to a branch instruction and memory access, by inputting a test script to a script engine and causing the script engine to execute the test script; a type conversion function detection unit which specifies a similar sequence on the basis of the plurality of execution traces and detects a function call included in the specified sequence as a candidate for a type conversion function; an input/output detection unit which detects a variable having an input/output relationship from a variable of a candidate argument and a return value of the type conversion function among execution traces; a propagation leakage detection unit which executes a taint analysis on the type variable function of the variable having an input/output relationship of the type conversion function, and detects a propagation leak function indicating a type variable function in which a tag does not propagate between the input and output; a generation unit which generates a forced propagation rule for forcibly propagating the tag with respect to the propagation leakage function; and an analysis function imparting unit which imparts a taint analysis function to the script engine on the basis of the forced propagation rule.

### Advantageous Effects of Invention

According to the present invention, it is possible to provide various script engines with minute particle size taint analysis functions.

### BRIEF DESCRIPTION OF DRAWINGS

FIG. 1 is a functional block diagram which shows a structure of an analysis function imparting device according to the present invention.

FIG. 2 is a diagram showing an example of a test script.

FIG. 3 is a diagram showing an example of execution traces.

FIG. 4 is a diagram (1) for explaining a taint analysis.

FIG. 5 is a diagram (2) for explaining a taint analysis.

FIG. 6 is a diagram (3) for explaining a taint analysis.

FIG. 7 is a diagram (4) for explaining a taint analysis.

FIG. 8 is a diagram showing an example of forced propagation rule DB.

FIG. 9 is a flowchart showing a processing procedure of an execution trace acquisition unit.

FIG. 10 is a diagram for explaining the processing of a type conversion function detection unit.

FIG. 11 is a diagram for explaining a modified Smith-Waterman algorithm.

FIG. 12 is a flowchart which shows the processing procedure of the type conversion function detection unit.

FIG. 13 is a flowchart (1) which shows the processing of the modified Smith-Waterman algorithm.

FIG. 14 is a flowchart (2) which shows the processing of the modified Smith-Waterman algorithm.

FIG. 15 is a diagram for explaining the processing of an input/output detection unit.

FIG. 16 is a flowchart showing the processing procedure of the input/output detection unit.

FIG. 17 is a diagram for explaining the processing of a propagation leakage detection unit.

FIG. 18 is a flowchart showing a processing procedure of the propagation leakage detection unit.

FIG. 19 is a flowchart showing a processing procedure of a forced propagation rule generation unit.

FIG. 20 is a flowchart showing a processing procedure of a taint analysis function imparting unit.

FIG. 21 is a flowchart showing a processing procedure of the analysis function imparting device according to the present embodiment.

FIG. 22 is a diagram showing an example of a computer that executes an analysis function imparting program.

### DESCRIPTION OF EMBODIMENTS

An embodiment of analysis function imparting device, an analysis function imparting method, and an analysis function imparting program, according to the present application, will be described below in detail with reference to the drawings. Note that this embodiment is not intended to limit the scope of the present invention.

### EXAMPLES

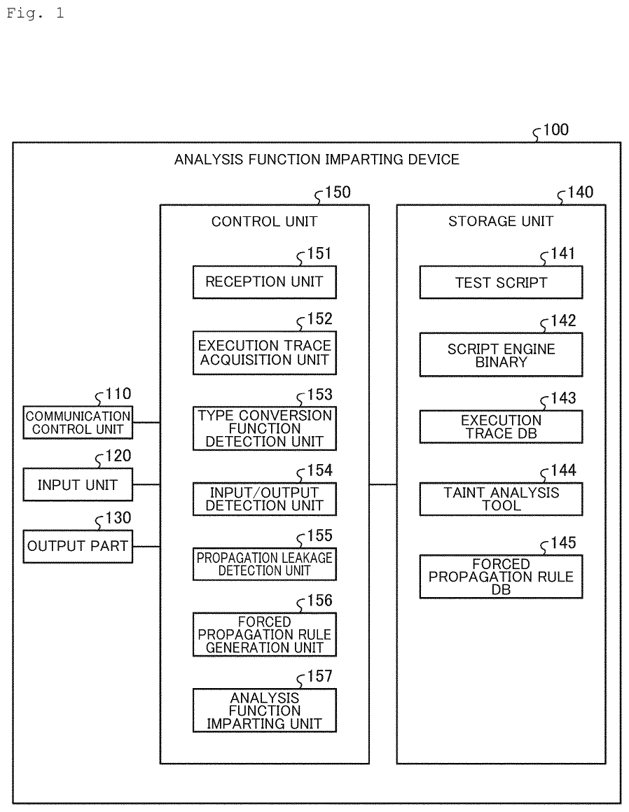

A configuration of an analysis function imparting device according to the embodiment of the present invention will be described. FIG. 1 is a block diagram showing the configuration of the analysis function imparting device according to an embodiment of the present invention. As shown in FIG. 1, an analysis function imparting device 100 includes a communication control unit 110, an input unit 120, an output unit 130, a storage unit 140, and a control unit 150. The analysis function imparting device 100 is implemented by a general-purpose computer such as a personal computer.

The communication control unit 110 is implemented by, for example, a network interface card (NIC), and controls communication between the control unit 150 and an external device via a telecommunication line such as a local area network (LAN) or the Internet.

The input unit 120 is implemented, using an input device such as a keyboard or a mouse, and inputs various pieces of instruction information, such as start of processing, to the control unit 150 in response to an input operation by an operator. The output unit 130 is implemented by a display device such as a liquid crystal display or a printing device such as a printer.

The storage unit 140 includes a test script 141, a script engine binary 142, an execution trace DB (Data Base) 143, a taint analysis tool 144, and a forced propagation rule DB 145.

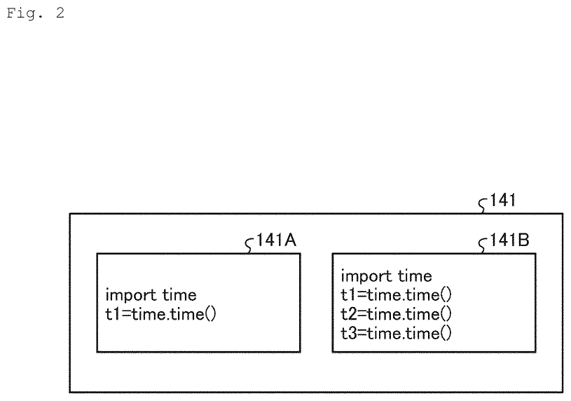

The test script 141 indicates a script for testing. FIG. 2 is a diagram of an example of the test script. For example, as shown in FIG. 2, the test script 141 has a script 141A and a script 141B.

The script engine binary 142 is a binary program of script engine (VM) that executes a script. Although not shown, the storage unit 140 stores data of a virtual machine for instrumentation. Such a virtual machine for instrumentation is a VM that hooks a binary program and enables monitoring during execution. For example, when a script is executed using a script engine binary 142 hooked on the virtual machine for instrumentation, the script can be executed while monitoring the script engine binary 142.

An execution trace DB 143 holds a trace obtained by causing the script engine binary 142 to execute the test script 141. In the following description, a trace obtained by causing the script engine binary 142 to execute the test script 141 is referred to as “execution trace”.

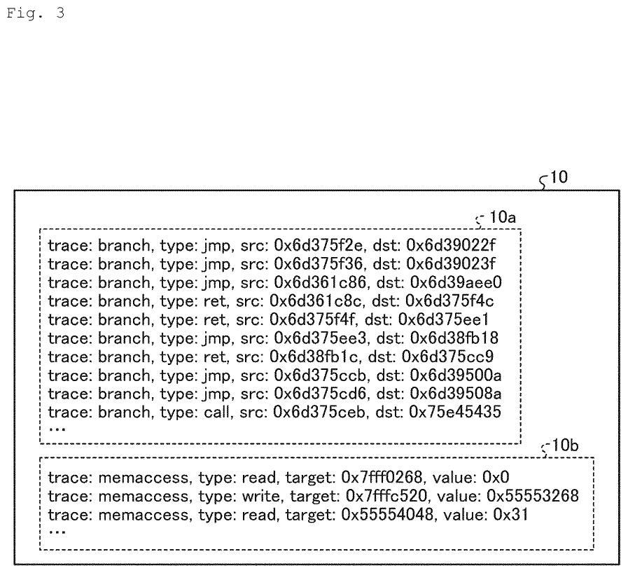

FIG. 3 is a diagram showing an example of the execution trace. As shown in FIG. 3, the execution trace 10 includes a trace 10a related to the branch instruction and a trace 10b related to the memory access. When a plurality of scripts are executed, an execution trace corresponding to each script is stored in the execution trace DB 143.

The taint analysis tool 144 is a tool for executing the taint analysis. By executing the taint analysis, a propagation leakage function can be detected.

The taint analysis is a technique for tracing and analyzing a flow of data in a program. In the taint analysis, attribute information called a taint tag is imparted to a specific data (taint source, hereinafter, referred to as a source) and the tag is propagated in accordance with the movement of the data. Then, in the taint analysis, a tag of a certain data (taint sink, hereafter referred to as sink) is confirmed, and the attribute of the data is specified.

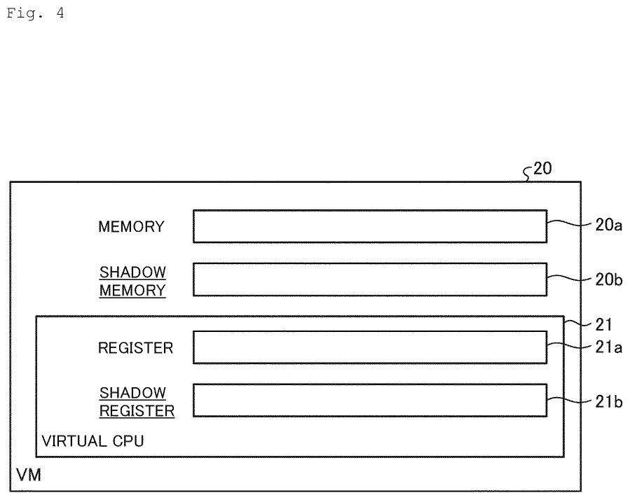

FIGS. 4 to 7 are diagrams for explaining the taint analysis. FIG. 4 will be described. The VM 20 includes a memory 20a and a virtual CPU 21, and the virtual CPU 21 includes a register 21a. In the taint analysis, a shadow memory 20b and a shadow register 21b are mounted on the VM 20 as regions for tag management.

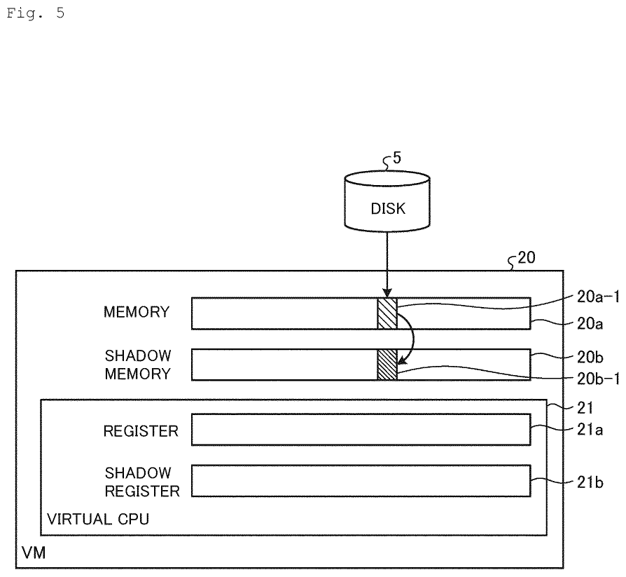

The explanation shifts to FIG. 5. In a case where data are written in a region 20a-1 of the memory 20a by specific writing, the tag 20b-1 is imparted to the shadow memory 20b. The specific writing corresponds to I/O (input output) or the like of the disk 5. In this case, the tag 20b-1 is provided with attribute information indicating that it corresponds to, for example, the disk 5.

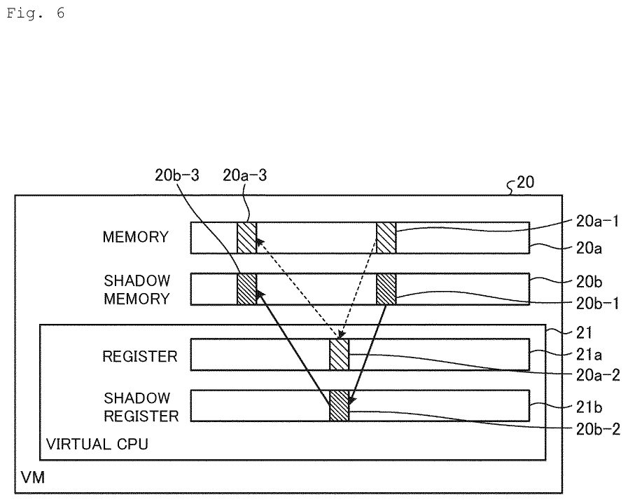

Description will return to FIG. 6. In the taint analysis, the tag is propagated in accordance with the movement or copy of the memory. For example, when the region 20a-1 moves to the region 20a-2 of the register 21a, the tag 20b-2 is set in the shadow register 21b. When the data of the region 20a-2 moves to the region 20a-3 of the memory 20a, the tag 20b-3 is set in the shadow memory 20b.

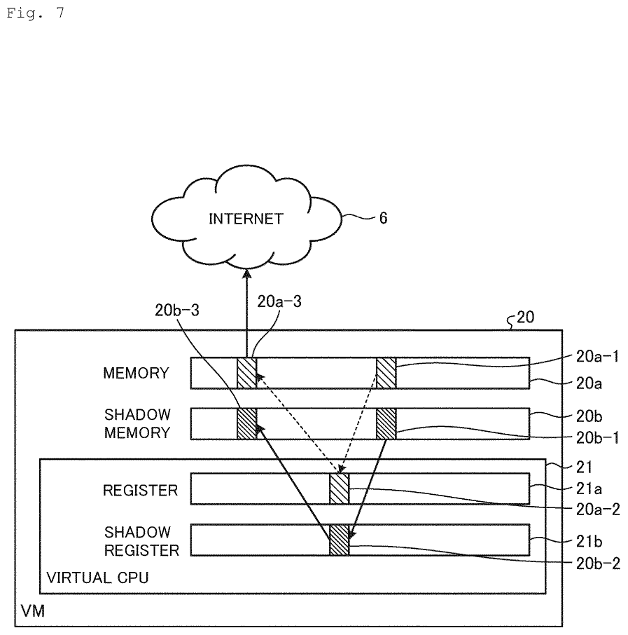

Description will return to FIG. 7 In the taint analysis, the distribution source of the data can be specified by confirming the tag at the time of reading a specific memory. The specific memory reading corresponds to communication or the like connected to the network 6. For example, by confirming the tags of the shadow memory 20b and the shadow register 21b, it can be specified that the distribution source of data is the disk 5.

In the process of propagating the tag by the taint analysis, there is a case where a function in which the tag does not propagate may be included in the script. For example, in taint analysis, it is possible to identify that the tag is not propagated, when the tag set in the source is not set in the sink between the source and the sink that originally have a data dependency. A function in which the tag does not propagate though the input/output has a dependency relation of data is expressed as a “propagation leakage function”,

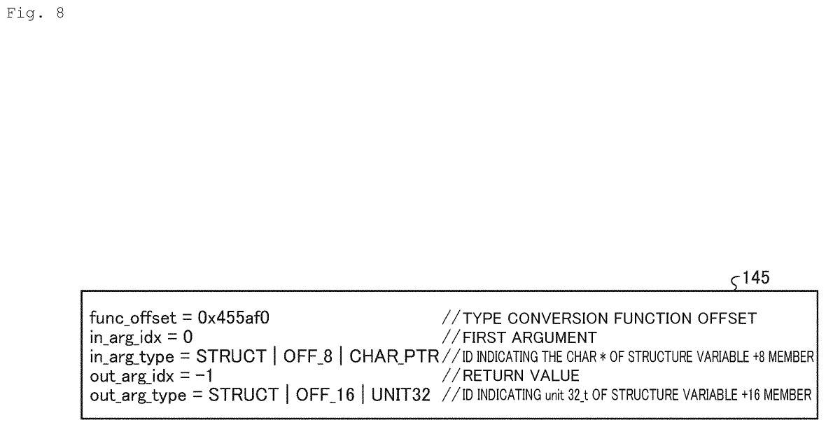

Description will return to FIG. 1. A forced propagation rule DB 145 holds a rule for forcibly propagating the tag to the propagation leakage function. A rule for forcibly propagating the tag to the propagation leakage function is expressed as a “forced propagation rule”. FIG. 8 is a diagram showing an example of the forced propagation rule DB. As shown in FIG. 8, a propagation leakage function, variables of input serving as a source, and variables of output serving as a sink by the propagation leakage function are defined. “func_offset” indicates the position of the propagation leakage function in the script engine binary by an offset. FIG. 8 shows that this propagation leakage function exists at a position “0x455af0” from the head of the script engine binary. “in_arg_idx” and “out_arg_idx” are subscripts indicating which argument or return value of the propagation leakage function the variables of the input and output correspond to. In FIG. 8, “in_arg_idx” is “0” indicates that the first argument is an input, and “out_arg_idx” is “1” indicates that the return value is an output. “in_arg_idx” and “out_arg_idx” indicate types of variables to be interpreted as input and output, respectively. In FIG. 8, the fact that “in_argo_type” is “STRUCT|OFF_8|CHAR_PTR” indicates that the input value can be obtained, when the first argument is interpreted as a structure and the member variable whose offset is +8 is interpreted as a char*type in addition to the fact that “in_argo_idx” is “0”. Further, the fact that “out_arg_type” is “STRUCT|OFF_16|UINT32” indicates that an output value is obtained by interpreting the return value as a structure together with the fact that “out_arg_idx” is “−1” and interpreting a member variable having an offset of +16 as a uint32_t type. Therefore, if a tag is attached to a memory in which the variable “in_arg_idx” included in the propagation leakage function at the position “func_offset” is interpreted by the type “in_arc_type”, the forced propagation rule indicates that the variable “out_arg_type” is forcibly propagated to the memory interpreted by the type “out_arg_type”.

When inputting a script into the virtual machine binary (script engine) 142 and executing the script, by imparting the ability to set a value for the propagation leakage function included in the script to the script engine according to the forced propagation rule, propagation leakage can be suppressed.

The control unit 150 has a reception unit 151, an execution trace acquisition unit 152, a type conversion function detection unit 153, an input/output detection unit 154, a propagation leakage detection unit 155, a forced propagation rule generation unit 156, and a taint analysis function imparting unit 157.

The reception unit 151 receives the input of the test script 141 and the script engine binary 142 from the input unit 120. The reception unit 151 stores the test script 141 and the script engine binary 142 in the storage unit 140. The reception unit 151 may receive the test script 141 and the script engine binary 142 from an external device via the communication control unit 110.

The execution trace acquisition unit 152 inputs the test script 141 into the script engine binary 142 and executes it, acquires a trace, and stores the acquired trace in the execution trace DB 143. For example, the execution trace acquisition unit 152 sets a hook for acquiring a trace in the script engine binary 142. The hook is a function for interrupting the processing of the program by the unique processing.

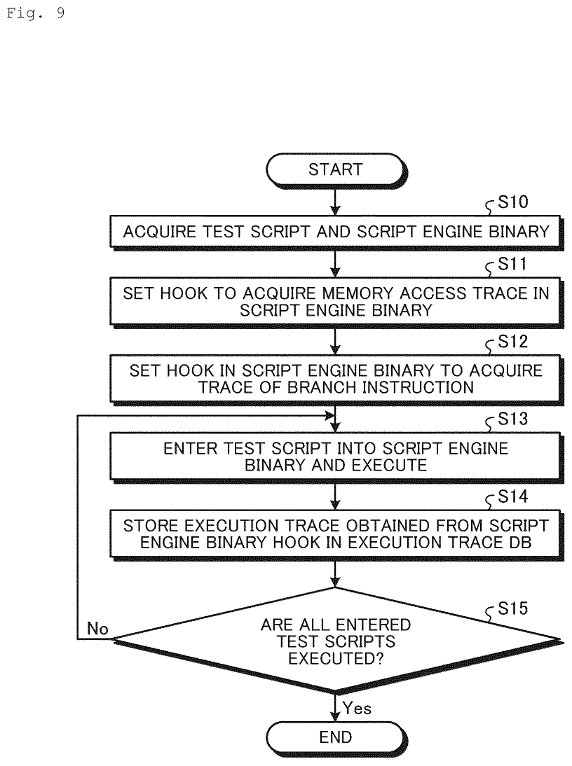

FIG. 9 is a flow chart showing the processing procedure of the execution trace acquisition unit. As shown in FIG. 9, the execution trace acquisition unit 152 acquires the test script 141 and the script engine binary 142 (step S10). The execution trace acquisition unit 152 sets a hook for acquiring a memory access trace in the script engine binary 142 (step S11).

The execution trace acquisition unit 152 sets a hook for acquiring the trace of the branch instruction to the script engine binary 142 (step S12). The execution trace acquisition unit 152 inputs the test script 141 to the script engine binary 142 and executes it (step S13).

The execution trace acquisition unit 152 stores an execution trace obtained from the hook of the script engine binary 142 in the execution trace DB 143 (step S14). When the execution trace acquisition unit 152 does not execute all the input test scripts 141 (steps S15, No), the process shifts to step S13. On the other hand, when the execution trace acquisition unit 152 executes all the input test scripts 141 (steps S15, Yes), the execution trace acquisition unit 152 ends the process.

Description will return to FIG. 1. The type conversion function detection unit 153 specifies a similar series on the basis of a plurality of execution traces stored in the execution trace DB 143, and detects a function call included in the specified series as a candidate of the type conversion function. For example, the type conversion function detection unit 153 detects candidates of the type conversion function, using a method called differential execution analysis.

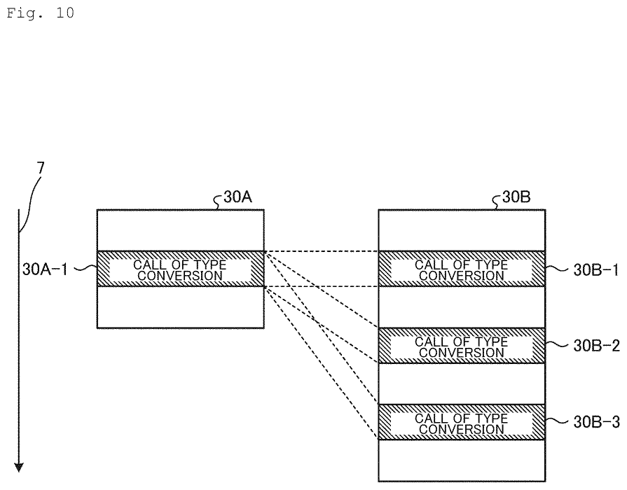

FIG. 10 is a diagram showing the processing of the type conversion function detection unit. In the example shown in FIG. 10, explanation will be made, using an execution trace and the execution trace 30B. The execution trace 30A is an execution trace obtained by executing the script 141A shown in FIG. 2 with a script engine binary 142. The execution trace 30B is an execution trace obtained by executing the script 141B shown in FIG. 2 with the script engine binary 142. A time-series direction of the trace related to the branch instruction is set to a direction 7.

The type conversion function detection unit 153 compares the series of the execution trace 30A with the series of the execution trace 30B in the order of the direction 7 of the execution trace 30A, and specifies a similar series. For example, it is assumed that the similarity between the series 30A-1 and the series 30B-1, 30B-2, and 30B-3 exceeds a predetermined threshold value. The type conversion function detection unit 153 extracts function calls included in the series 30A-1 and the series 30B-1, 30B-2, and 30B-3 in common as candidates of the type conversion function. The type conversion function detection unit 153 outputs information on candidate type conversion functions to the input/output detection unit 154.

In the test scripts 141A and 141 B shown in FIG. 2, “time.time ( )” is called once and three times, respectively. The called result is reflected in the execution trace, and the trace sequence of the branch corresponding to “time.time ( )” appears once for 30A corresponding to 141A (corresponding to 30A-1), and appears 3 times for 30B corresponding to 141B (corresponding to 30B-1, 30B-2, and 30B-3). In the time.time ( ), type conversion is internally performed, and it is expected that there is a call to the type conversion function in 30A-1, 30B-1, 30B-2, and 30B-3, respectively.

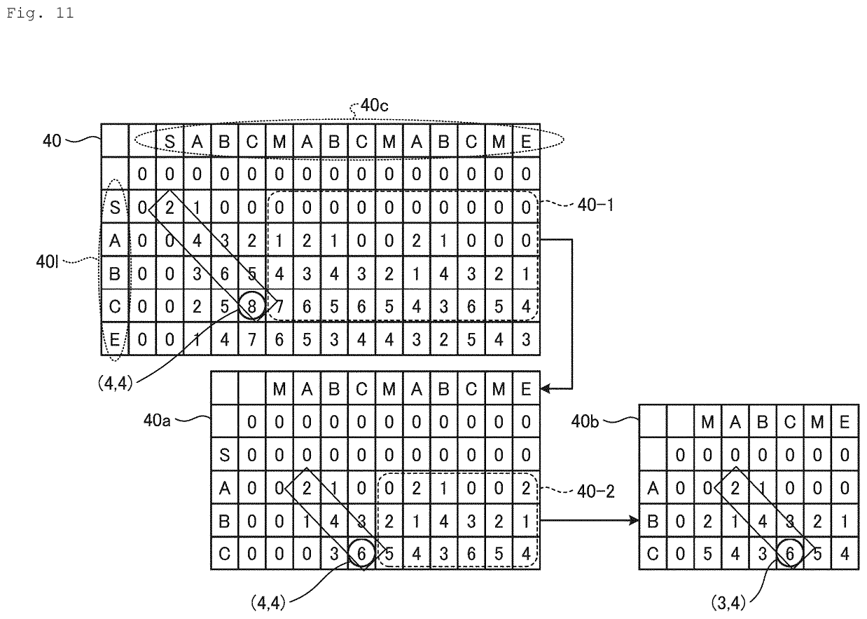

For example, the type conversion function detection unit 153 specifies a similar sequence by a modified Smith-Waterman algorithm. FIG. 11 is a diagram for explaining a modified Smith-Waterman algorithm. The type conversion function detection unit 153 sets a DP table 40, and sets an execution trace (for example, an execution trace 30A), which calls the type variable function once, in a front-side (row) 401 of the DP table 40. The type conversion function detection unit 153 sets an execution trace (for example, an execution trace 30B), which calls the type variable function N times, in a table head (column) 40C of the DP table 40.

The type conversion function detection unit 153 sets a value calculated by the match score F(i, j) to each cell (i, j) of the DP table 40. i corresponds an i-th row, and j corresponds to a j-th column. The initial values of i and j are set to “0”.

For example, the type conversion function detection unit 153 calculates a match score F(i, j) on the basis of the Equation (1). S(i, j) included in the Equation (1) is defined by Equation (2). In addition, “−1” is set in d of Equation (1).

$$\\ \begin{matrix}[ Math . 1 ] & \\ F ( i , j ) = max \{ \begin{matrix}0 \\ F ( i - 1 , j - 1 ) + s ( i , j ) \\ F ( i - 1 , j ) + d \\ F ( i , j - 1 ) + d\end{matrix} & ( 1 )\end{matrix}$$

$$\\ \begin{matrix}[ Math . 2 ] & \\ s ( i , j ) = \{ \begin{matrix}2 ( match ) \\ - 2 ( unmatch )\end{matrix} & ( 2 )\end{matrix}$$

The type conversion function detection unit 153 extracts a cell (4, 4) whose match score becomes the maximum after setting the match score to each cell, performs back-tracking with the extracted cell as a base point, and extracts a sequence having the highest homology. The type conversion function detection unit 153 extracts a sequence “SABC” from the DP table 40 of FIG. 11.

The type conversion function detection unit 153 generates a new DP table 40a, using a part 40-1 excluding a part related to the extracted series. The type conversion function detection unit 153 sets a value calculated by the match score F(i, j) to each cell (i, j) of the DP table 40a.

The type conversion function detection unit 153 extracts a cell (4, 4) whose match score becomes the maximum after setting the match score to each cell, performs back-tracking with the extracted cell as a base point, and extracts a sequence having the highest homology. The type conversion function detection unit 153 extracts a sequence “ABC” from the DP table 40a of FIG. 11.

The type conversion function detection unit 153 generates a new DP table 40b, using a part 40-2 excluding a part related to the extracted series. The type conversion function detection unit 153 sets a value calculated by the match score F(i, j) to each cell (i, j) of the DP table 40b.

The type conversion function detection unit 153 extracts a cell (3, 4) whose match score becomes the maximum after setting the match score to each cell, and performs back-tracking with the extracted cell as a base point to extract a sequence having the highest homology. The type conversion function detection unit 153 extracts a sequence “ABC” from the DP table 40b of FIG. 11.

The type conversion function detection unit 153 specifies similar sequences “SABC”, “ABC”, and “ABC” by executing the above processing.

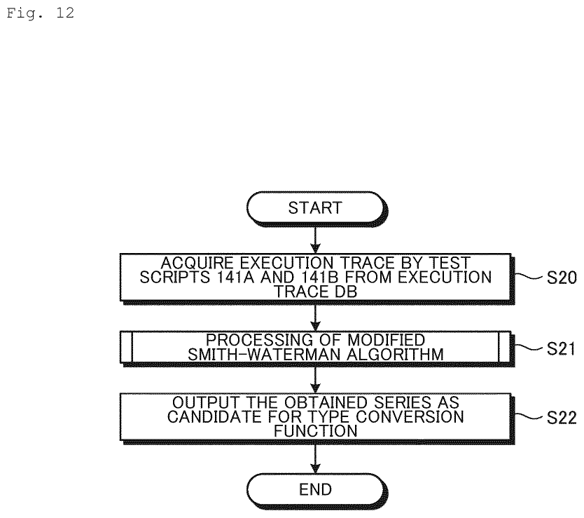

FIG. 12 is a flow chart showing the processing procedure of the type conversion function detection unit. As shown in FIG. 12, the type conversion function detection unit 153 acquires execution traces by test scripts 141A and 141B from the execution trace DB 143 (step S20).

The type conversion function detection unit 153 executes processing of a modified Smith-Waterman algorithm (step S21). The type conversion function detection unit 153 outputs the obtained coefficient as a candidate of the type conversion function (step S22).

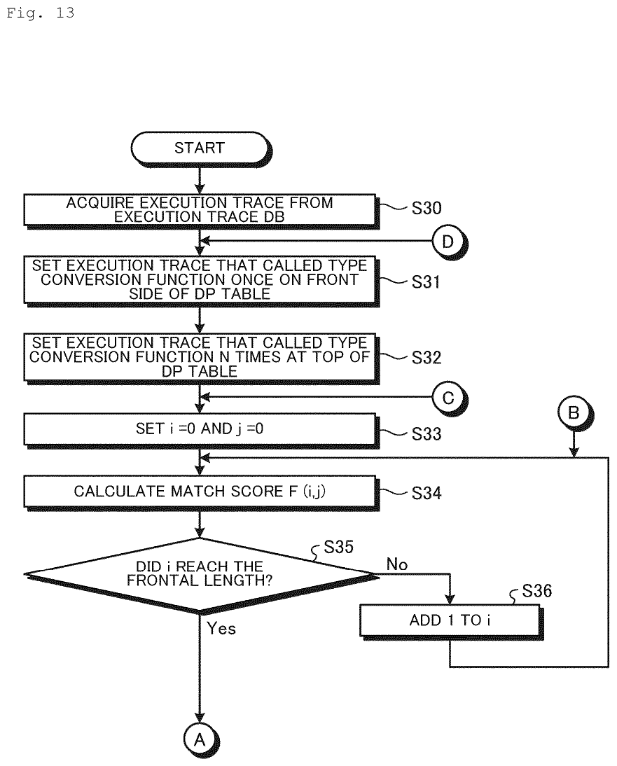

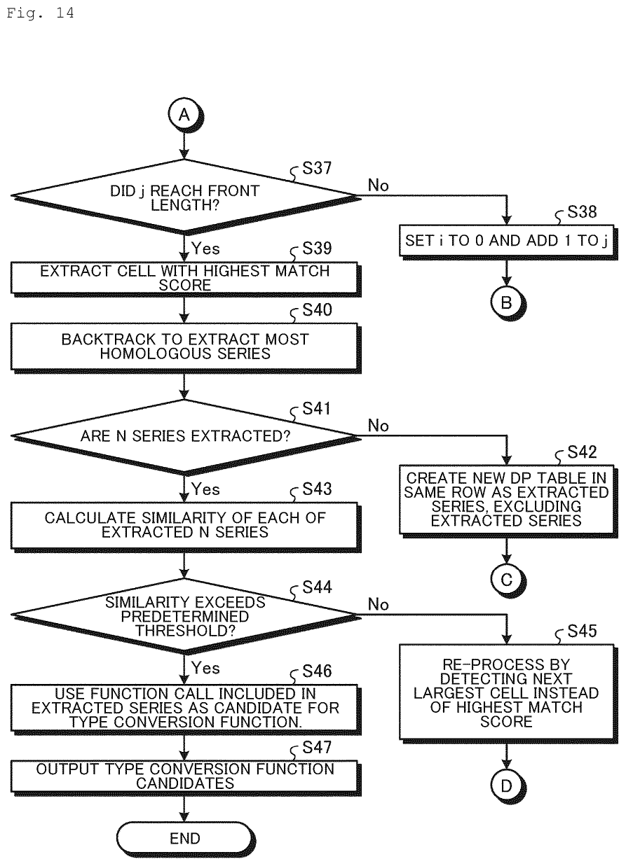

Next, an example of the processing of the modified Smith-Waterman algorithm shown in step S21 of FIG. 12 will be described. FIGS. 13 and 14 are flow charts showing the processing of the modified Smith-Waterman algorithm.

FIG. 13 will be described. The type conversion function detection unit 153 acquires an execution trace from the execution trace DB 143 (step S30). The type conversion function detection unit 153 sets an execution trace, which calls the type conversion function once, on the front side of the DP table (step S31).

The type conversion function detection unit 153 sets an execution trace, which calls the type conversion function N times, on the table head of the DP table (step S32). The type conversion function detection unit 153 sets i=0, j=0 (step S33). The type conversion function detection unit 153 calculates a match score F (i, j) (step S34).

When i does not reach the length of the front head (step S35, No), the type conversion function detection unit 153 adds 1 to i (step S36), and shifts to step S34.

On the other hand, when i reaches the length of the table head (step S35, Yes), the type conversion function detection unit 153 shifts to the step S37 of FIG. 14.

The explanation shifts to FIG. 14. When j does not reach the length of the front side (step S37, No), the type conversion function detection unit 153 sets 0 to i, adds 1 to j (step S38), and shifts to a step S34 of FIG. 13.

When j reaches the length of the front side (step S37, Yes), the type conversion function detection unit 153 extracts a cell whose match score becomes the maximum (step S39). The type conversion function detection unit 153 extracts a sequence having the highest homology by performing back-tracking (step S40).

When N series are not extracted (step S41, No), the type conversion function detection unit 153 newly creates a DP table in a part excluding a series extracted in the same row as the extracted series (step S42), and shifts to step S33 of FIG. 13.

When the N series is extracted (step S41, Yes), the type conversion function detection unit 153 calculates the similarity of each of all the extracted N series (step S43). When the similarity does not exceed a predetermined threshold (step S44, No), the type conversion function detection unit 153 extracts the next largest cell instead of the highest match score to perform processing (processing after step S39) again (step S45), and shifts to step S31 of FIG. 13.

On the other hand, when the similarity exceeds the predetermined threshold (step S44, Yes), the type conversion function detection unit 153 determines a function call included in the extracted sequence as a candidate of the type conversion function (step S46). The type conversion function detection unit 153 outputs a candidate of a type conversion function (step S47).

Description will return to FIG. 1. The input/output detection unit 154 detects a variable having an input/output relation from the argument and return value of the candidate of the type conversion function in the execution trace. The input/output detection unit 154 outputs a variable having the detected input/output relation and information on a type variable function corresponding to the variable to the propagation leakage detection unit 155. When a variable having an input/output relation is specified, a type variable function of the variable is specified.

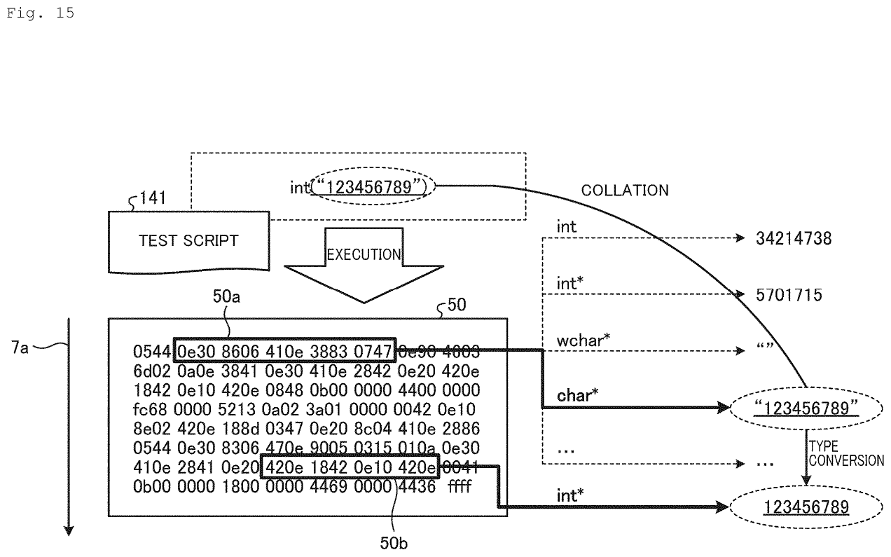

FIG. 15 is a diagram for explaining the processing of the input/output detection unit. The input/output detection unit 154 inputs and executes the test script 141 to the script engine binary 142, and acquires an execution trace corresponding to the test script 141 from the execution trace DB 143. The input/output detection unit 154 develops the execution trace in a memory region 50.

The input/output detection unit 154 specifies a value “123456789” set to a predetermined function included in the test script 141. A value set in a predetermined function is appropriately expressed as a “set value”. The input/output detection unit 154 specifies a region corresponding to the candidate of the type conversion function among the execution traces developed in the memory region 50.

The input/output detection unit 154 executes static analysis for each partial region to a region corresponding to the candidate of the type conversion function, and estimates the type of the structure included in the partial region. The input/output detection unit 154 applies a plurality of types and specifies a value corresponding to the applied type.

In the example shown in FIG. 15, the structure included in the partial region 50a will be described. When a type “int” is applied to the input/output detection unit 154, the value becomes “34214738”. When the type “int” is applied to the input/output detection unit 154, the value becomes “5701715”. When the type “wchar*” is applied to the input/output detection unit 154, the value becomes “”. When the type “char*” is applied to the input/output detection unit 154, the value becomes “123456789”. In the input/output detection unit 154, the value when the type “char*” is applied is “123456789”, which matches the set value. The input/output detection unit 154 extracts the value “123456789” when the type “char*” is applied as an input value.

Next, a structure included in the partial region 50a will be described. When the type “int*” is applied to the input/output detection unit 154, the value becomes “123456789”. The input/output detection unit 154 has a value (return value) of “123456789” when the type “int*” is applied, and matches the input value (determines that consistency is high).

By the above processing, the input/output detection unit 154 specifies that the relationship when the type “char*” is applied to the partial region 50a and the type “int*” is applied to the partial region 50b is a type conversion. The input/output detection unit 154 specifies the partial regions 50a and 50b as a variable having an input/output relation. When the time series direction is 7a, the variable on the input side becomes the partial region 50a, and the variable on the output side becomes the partial region 50b.

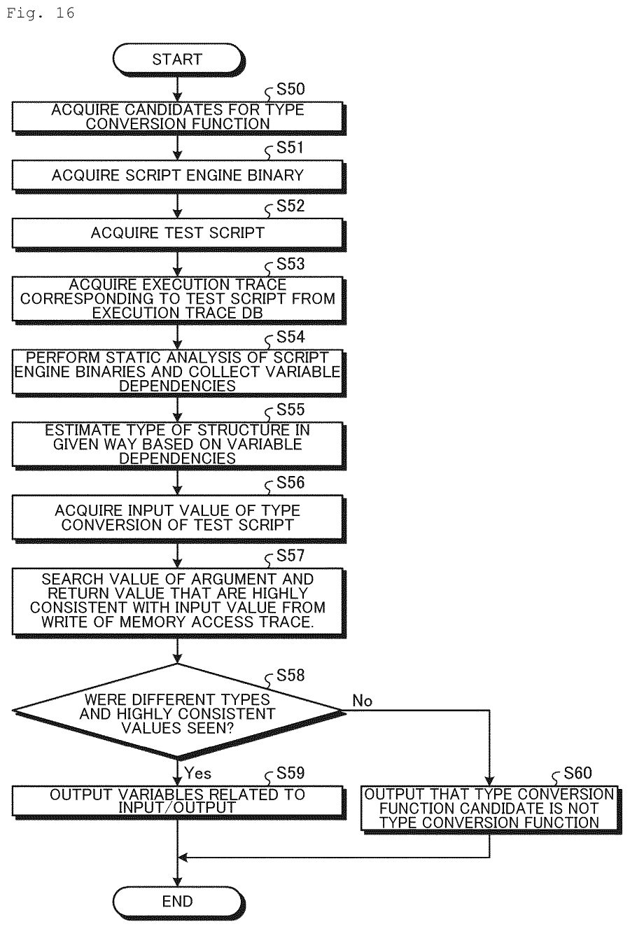

FIG. 16 is a flow chart showing the processing procedure of the input/output detection unit. As shown in FIG. 16, the input/output detection unit 154 acquires candidates of the type conversion function (step S50). The input/output detection unit 154 acquires the script engine binary 142 (step S51). The input/output detection unit 154 acquires the test script 141 (step S52).

The input/output detection unit 154 acquires an execution trace corresponding to the test script 141 from the execution trace DB 143 (step S53). The input/output detection unit 154 performs static analysis of the script engine binary 142, and collects dependency relation of variables (step S54).

The input/output detection unit 154 estimates the type of the structure by a predetermined method on the basis of the dependency relation of the variables (step S55). The input/output detection unit 154 acquires an input value of the type conversion of the test script 141 (step S56). The input/output detection unit 154 searches for values of an argument and a return value having high consistency with an input value from writing of the memory access trace (step S57).

When a value of a different type and high consistency is found (step S58, Yes), the input/output detection unit 154 outputs a variable having an input/output relation to the propagation leakage detection unit 155 (step S59). On the other hand, when the value of the different type and high consistency is not found (step S58, No), the input/output detection unit 154 outputs the effect that the candidate of the type conversion function is not the type conversion function (step S60).

The input/output detection unit 154 detects the input/output even when the predetermined function of the test script 141 does not include the value such as “123456789”. In this case, the input/output detection unit 154 searches for each variable without determining a value to be searched in advance, and detects as the input/output a set of values that are different types and have high consistency.

Description will return to FIG. 1. The propagation leakage detection unit 155 executes a taint analysis to a type conversion function of a variable having an input/output relation of the type conversion function, and detects a propagation leakage function indicating the type conversion function in which the tag does not propagate. The propagation leakage detection unit 155 outputs the propagation leakage function and information on input/output of the propagation leakage function to the forced propagation rule generation unit 156.

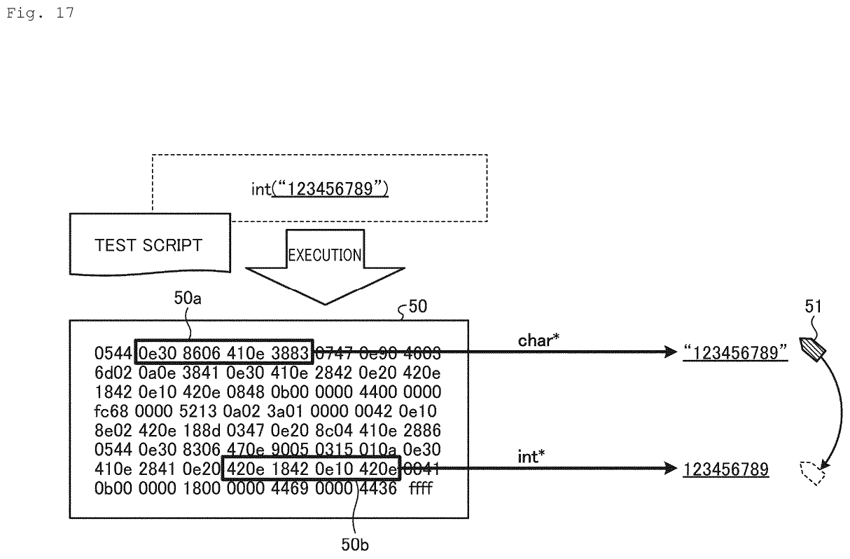

FIG. 17 is a diagram for explaining the processing of the propagation leakage detection unit. The propagation leakage detection unit 155 sets a tag 51 with a variable to be an input of a type conversion function as a source, and executes a taint analysis. For example, the propagation leakage detection unit 155 reads out and executes the taint analysis tool 144 to execute the taint analysis. When a variable to be an output of the type conversion function is defined as a sink, and when the tag 51 is not propagated and the tag 51 is lost, the propagation leakage detection unit 155 detects the type conversion function of variables related to input/output as a propagation leakage function.

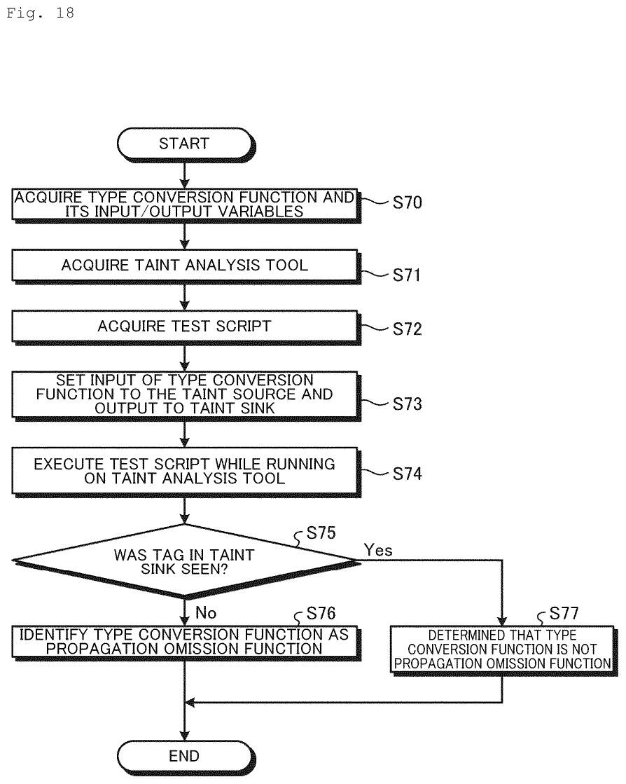

FIG. 18 is a flow chart showing the processing procedure of the propagation leakage detection unit. As shown in FIG. 18, the propagation leakage detection unit 155 acquires the type conversion function and the input/output variables thereof (step S70). The propagation leakage detection unit 155 acquires a taint analysis tool 144 (step S71). The propagation leakage detection unit 155 acquires the test script (step S72).

The propagation leakage detection unit 155 sets an input of a type conversion function to a tail source and sets an output to a tail sink (step S73). The propagation leakage detection unit 155 executes a test script, while executing on a taint analysis tool (step S74).

When the tag is not seen in the taint sink (step S75, No), the propagation leakage detection unit 155 specifies a type conversion function as a propagation leakage function (step S76). When the tag is seen in the taint sink (step S75, Yes), The propagation leakage detection unit 155 determines that the type conversion function is not a propagation leakage function (step S77).

Description will return to FIG. 1. The forced propagation rule generation unit 156 generates a forced propagation rule on the basis of the propagation leakage function and input/output information of the propagation leakage function.

For example, the forced propagation rule generation unit 156 generates “func_offset=0x455af0” when the binary offset of the propagation leakage function becomes 0x. When the input of the propagation leakage function is a first argument, “in_arg_idx=0” is generated. For example, when the output of the propagation leakage function is a return value, “out_arg_idx=−1” is generated. Also, for example, when an input is interpreted as a structure and a member variable whose offset is +8 is interpreted as a char*type to obtain an input value, “in_arg_type=STRUCT|OFF_8|CHAR_PTR” is generated, When an output value is obtained by interpreting the output as a structure and interpreting a member variable whose offset is +16 as a uint32t type, “out_arg_type=STRUCT|OFF_16|uint32” is generated.

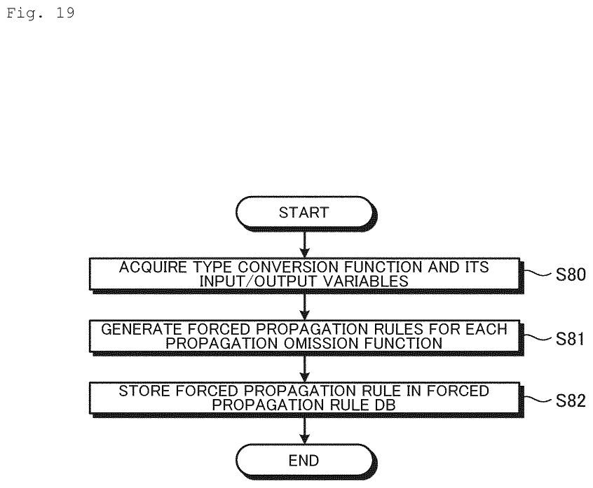

FIG. 19 is a flow chart showing the processing procedure of the forced propagation rule generation unit. As shown in FIG. 19, the forced propagation rule generation unit 156 obtains the type conversion function and the input/output variables thereof (step S80).

The forced propagation rule generation unit 156 generates a forced propagation rule for each propagation leakage function (step S81). The forced propagation rule generation unit 156 stores a forced propagation rule in the forced propagation rule DB 145 (step S82).

Description will return to FIG. 1. The taint analysis function imparting unit 157 imparts an analysis function to the script engine binary 142 on the basis of the forced propagation rule.

The taint analysis function imparting unit 157 sets a script engine binary 142 to be executable, sets a hook for confirming the presence/absence of a tag by the input of the forced propagation rule, and sets a hook for imparting the tag to the output when the tag is present by the input of the forced propagation rule.

For example, when executing a script by the script engine binary 142, the taint analysis function imparting unit 157 refers to an input value of a propagation leakage function along description of a forced propagation rule (corresponds to the forced propagation rule “in_arg_idx” and “in_arg_type”), when the tag is imparted, the taint analysis function imparting unit 157 refers to the output value of the propagation leakage function along the description of the forced propagation rule (corresponds to forced propagation rules “out_arg_idx” and “out_arg_type”), and imparts the analysis function to the script engine binary 142 to forcibly impart the tag. The taint analysis function imparting unit 157 outputs the script engine binary 142 to which the analysis function is imparted as a taint analysis tool for the script.

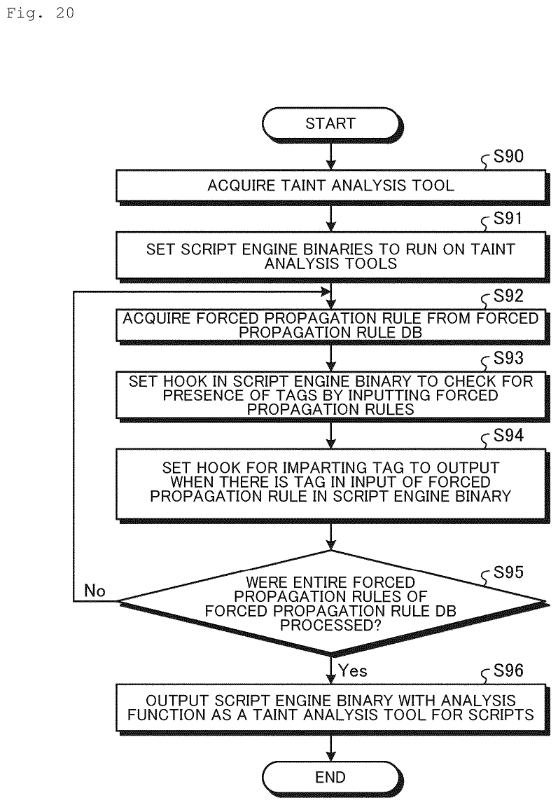

FIG. 20 is a flow chart showing the processing procedure of the taint analysis function imparting unit. As shown in FIG. 20, the taint analysis function imparting unit 157 acquires a taint analysis tool 144 (step S90). The taint analysis function imparting unit 157 sets the script engine binary 142 to be executed on the taint analysis tool 144 (step S91).

The taint analysis function imparting unit 157 acquires a forced propagation rule from the forced propagation rule DB 145 (step S92). The taint analysis function imparting unit 157 sets a hook for confirming the presence/absence of a tag by the input of a forced propagation rule in the script engine binary 142 (step S93).

When a tag is present in the virtual machine binary by the input of the forced propagation rule, a taint analysis function imparting unit 157 sets a hook for imparting the tag to the output (step S94). When all of the forced propagation rules of the forced propagation rule DB are not processed (step S95, No), the taint analysis function imparting unit 157 shifts to step S92.

When all the forced propagation rules of the forced propagation rule DB are processed (step S95, Yes), the taint analysis function imparting unit 157 outputs the script engine binary 142 to which an analysis function is imparted as a taint analysis tool for a script (step S96).

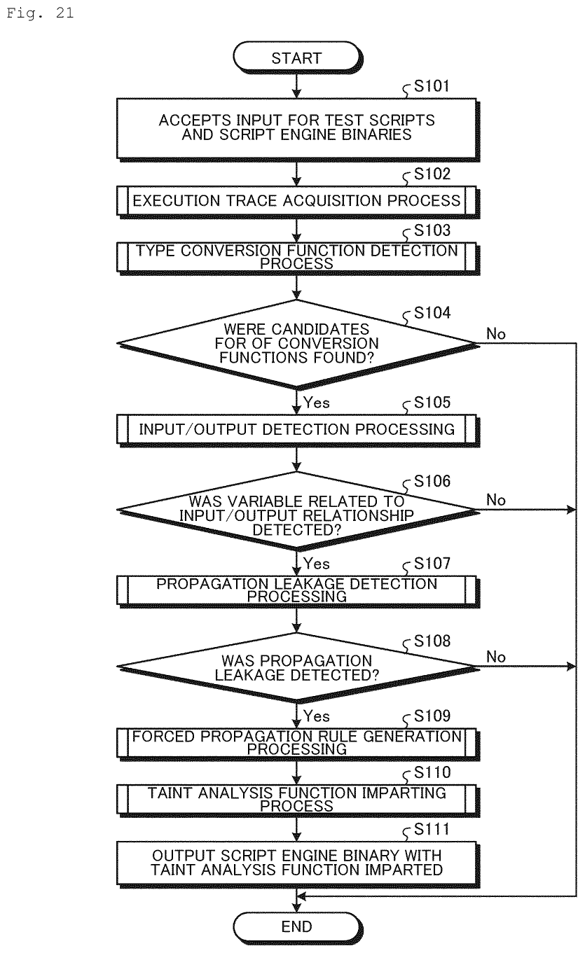

Next, the processing procedure of the analysis function imparting device 100 will be described. FIG. 21 is a flowchart showing the processing procedure of the analysis function imparting device according to the present embodiment. As shown in FIG. 21, a reception unit 151 of the analysis function imparting device 100 receives input of a test script 141 and a virtual machine binary (step S101).

The execution trace acquisition unit 152 of the analysis function imparting device 100 executes execution trace acquisition processing (step S102). The execution trace acquisition processing shown in step S102 corresponds to the processing procedure shown in FIG. 9.

The type conversion function detection unit 153 of the analysis function imparting device 100 executes a type conversion function detection process (step S103). The type conversion function detection processing shown in step S103 corresponds to the processing procedure shown in FIG. 12.

When the candidate of the type conversion function is not detected (step S104), the analysis function imparting device 100 terminates the processing. On the other hand, when the candidate of the type conversion function is detected (step S104, Yes), the analysis function imparting device 100 shifts to step S105.

The input/output detection unit 154 of the analysis function imparting device 100 executes input/output detection processing (step S105). The input/output detection processing shown in step S105 corresponds to the processing procedure shown in FIG. 16.

The analysis function imparting device 100 terminates the processing, when a variable in the input/output relation is not detected (step S106, No). On the other hand, when a variable having an input/output relation is detected (step S106, Yes), the analysis function imparting device 100 shifts to step S107.

The propagation leakage detection unit 155 of the analysis function imparting device 100 executes a propagation leakage detection process (step S107). The propagation leakage detection processing shown in step S107 corresponds to the processing procedure shown in FIG. 18.

When the propagation leakage is not detected (step S108, No), the analysis function imparting device 100 terminates the processing. On the other hand, when the leakage of propagation is detected (step S108, Yes), the analysis function imparting device 100 shifts to step S109.

The forced propagation rule generation unit 156 of the analysis function imparting device 100 executes forced propagation rule generation processing (step S109). The forced propagation rule generation processing shown in step S109 corresponds to the processing procedure shown in FIG. 19.

The analysis function imparting device 100 executes a taint analysis function imparting processing (step S110). The taint analysis function imparting processing shown in step S110 corresponds to the processing procedure shown in FIG. 20. The analysis function imparting device 100 outputs the script engine binary 142 to which the taint function is imparted (step S111).

Next, the effect of the analysis function imparting device 100 according to this embodiment will be described. The analysis function imparting device 100 acquires a plurality of execution traces by inputting and executing the test script 141 to the script engine binary 142, and detects candidates of the type conversion function on the basis of the plurality of execution traces. The analysis function imparting device 100 executes a search by static analysis of the structure and collation of values for the candidate of the type conversion function, and detects input/output of the type conversion function.

The analysis function imparting device 100 detects a propagation leakage by a taint analysis using input and output of a type conversion relation function as a source and a sink, and generates a forced propagation rule for the propagation leak. The analysis function imparting device 100 forcibly propagates the tag by hooking the script engine binary 142 (script engine) using the forced propagation rule, eliminates the propagation leakage, and imparts the taint analysis function.

Accordingly, even for a proprietary script engine that can only be obtained in binary, it is possible to generate a forced propagation rule and impart a taint analysis function, without requiring manual reverse engineering.

Thus, the analysis function imparting device can realize the taint analysis without requiring individual design and mounting for a script engine and a script language and without information of prior internal mounting.

Since the analysis function imparting device 100 does not require code injection to the script body, the taint analysis can also be applied to the obfuscated malignant script.

In the analysis function imparting device 100, since the instruction-level taint analysis provided by the taint analysis tool for binaries can be applied to the script as it is, it is possible to impart a fine-grained taint analysis function.

The analysis function imparting device 100 sets a tag in the tint source on the input side, propagates the tag according to the processing related to the function (movement or copying of memory), and detects the type conversion function as a propagation leakage function, when the tag is not output in the tainting. Thus, it is possible to detect a type conversion function that causes propagation leakage.

The analysis function imparting device 100 can suppress propagation leakage, by imparting a function for forcibly outputting a tag input to a variable on an input side of the propagation leakage function from a variable on an output side to a script engine binary 142, on the basis of the forced propagation rule.

In this way, according to the analysis function imparting device 100, by analyzing the script engine and imparting the taint analysis function afterwards, it is possible to automatically impart the analysis function also suitable for the analysis of malicious scripts to the script engine of various script languages.

As described above, the analysis function imparting device 100 is useful in analyzing the behavior of malicious script described in a wide variety of script languages, and is suitable for performing taint analysis on malicious scripts, without being affected by obfuscation. Therefore, the analysis function imparting device 100 can analyze the data flow of the malignant script and utilize it for measures such as detection, by imparting the taint analysis function to various script engines.

Although description has been made for the script language and the script engine in the above-described embodiment 1, the objects are not necessarily limited thereto. That is, the analysis function imparting device 100 can be similarly configured for a language processing system having a mechanism in which a byte code is generated by inputting a source code, and the byte code is interpreted and executed by a virtual machine. Thus, it can be realized for language and execution engines which are not script language, such as Java and its virtual machine JVM.

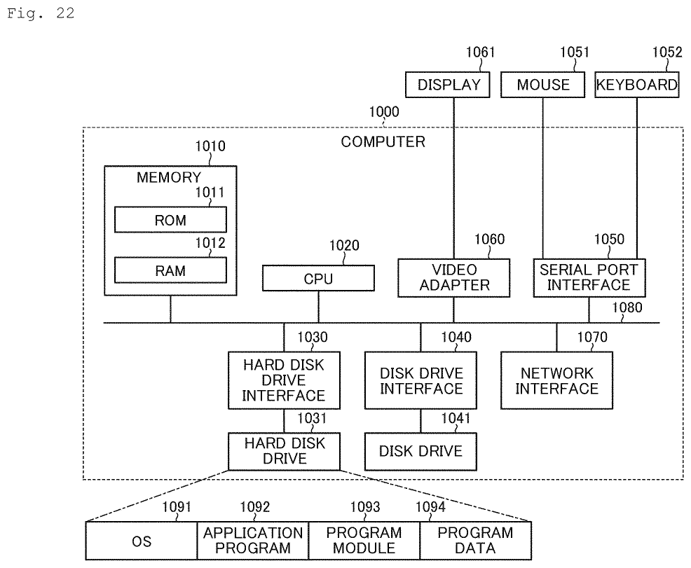

FIG. 22 is a diagram showing an example of a computer that executes an analysis function imparting program. A computer 1000 includes, for example, a memory 1010, a CPU 1020, a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to the hard disk drive 1031. The disk drive interface 1040 is connected to a disk drive 1041. A detachable storage medium such as a magnetic disk or an optical disk, for example, is inserted into the disk drive 1041. A mouse 1051 and a keyboard 1052, for example, are connected to the serial port interface 1050. A display 1061, for example, is connected to the video adapter 1060.

Here, the hard disk drive 1031 stores, for example, an OS 1091, an application program 1092, a program module 1093, and program data 1094. Bach of the pieces of information described in the above embodiment is stored in, for example, the hard disk drive 1031 or the memory 1010.

Further, the analysis function imparting program is stored in the hard disk drive 1031 as, for example, a program module 1093 in which a command executed by the computer 1000 is described. Specifically, the program module 1093 in which respective processes executed by the analysis function imparting device 100 described in the embodiment are described is stored in the hard disk drive 1031.

The data used for information processing by the analysis function imparting program is stored in the hard disk drive 1031, for example, as the program data 1094. Thereafter, the CPU 1020 reads out and loads the program module 1093 and the program data 1094 stored in the hard disk drive 1031 to the RAM 1012 when necessary, and executes each of the above-described procedures.

The program module 1093 and the program data 1094 according to the analysis function imparting program are not limited to a case of being stored in the hard disk drive 1031, and may also be stored in, for example, a detachable storage medium and read out by the CPU 1020 via the disk drive 1041, etc. Alternatively, the program module 1093 and the program data 1094 according to the analysis function imparting program may be stored in another computer connected via a network such as a LAN or wide area network (WAN), and may be read out by the CPU 1020 via the network interface 1070.

Although the embodiment to which the invention made by the present inventor has been applied has been described above, the present invention is not limited by the description and the drawings that form a part of the disclosure of the present invention according to the present embodiment. That is, other embodiments, examples, operational techniques, and the like made by those skilled in the art or the like on the basis of the present embodiment are all included in the category of the present invention.

### REFERENCE SIGNS LIST

100 Analysis function imparting device

110 Communication control unit

120 Input unit

130 Output unit

140 Storage unit

141 Test script

142 Script engine binary

143 Execution trace DB

144 Analysis tool unit

145 Forced propagation rule DB

150 Control unit

151 Reception unit

152 Execution trace acquisition unit

153 Type conversion function detection unit

154 Input/output detection unit

155 Propagation leakage detection unit

156 Forced propagation rule generation unit

157 Taint analysis function imparting unit

1. An analysis function imparting device comprising:
execution trace acquisition circuitry which acquires a plurality of execution traces related to a branch instruction and a memory access, by inputting a test script to a script engine and causing the script engine to execute the test script;
type conversion function detection circuitry which specifies a similar sequence on the basis of the plurality of execution traces and detects a function call included in the specified sequence as a candidate of a type conversion function;
input/output detection circuitry which detects a variable having an input/output relationship from a variable of a candidate argument and a return value of the type conversion function among the execution traces;
propagation leakage detection circuitry which executes a taint analysis on the type variable function of the variable having the input/output relationship of the type conversion function, and detects a propagation leakage function indicating a type variable function in which a tag does not propagate between the input and output;
generation circuitry which generates a forced propagation rule for forcibly propagating the tag with respect to the propagation leakage function; and
analysis function imparting circuitry which imparts a taint analysis function to the script engine on the basis of the forced propagation rule.

2. The analysis function imparting device according to claim 1,
wherein the propagation leakage detection circuitry sets a tag to a variable on an input side, propagates the tag in accordance with processing related to the type conversion function, and detects the type conversion function as the propagation leakage function, when the tag is not output in the variable on the output side.

3. The analysis function imparting device according to claim 1,
wherein the analysis function imparting circuitry imparts to the script engine a function in which a tag input to the variable on the input side of the propagation leakage function is output from the variable on the output side on the basis of the forced propagation rule.

4. An analysis function imparting method executed by an analysis function imparting device, the method comprising:
acquiring a plurality of execution traces related to a branch instruction and a memory access, by inputting a test script to a script engine and causing the script engine to execute the test script;
specifying a similar sequence on the basis of the plurality of execution traces and detects a function call included in the specified sequence as a candidate of a type conversion function;
detecting a variable having an input/output relationship from a variable of a candidate argument and a return value of the type conversion function among the execution traces;
executing a taint analysis on the type variable function of the variable having the input/output relationship of the type conversion function, and detecting a propagation leakage function indicating a type variable function in which a tag does not propagate between the input and output;
generating a forced propagation rule for forcibly propagating the tag with respect to the propagation leakage function; and
imparting a taint analysis function to the script engine on the basis of the forced propagation rule.

5. An analysis function imparting program which causes a computer to execute:
acquiring a plurality of execution traces related to a branch instruction and a memory access, by inputting a test script to a script engine and causing the script engine to execute the test script;
specifying a similar sequence on the basis of the plurality of execution traces and detects a function call included in the specified sequence as a candidate of a type conversion function;
detecting a variable having an input/output relationship from a variable of a candidate argument and a return value of the type conversion function among the execution traces;
executing a taint analysis on the type variable function of the variable having the input/output relationship of the type conversion function, and detects a propagation leakage function indicating a type variable function in which a tag does not propagate between the input and output;
generating a forced propagation rule for forcibly propagating the tag with respect to the propagation leakage function; and
imparting a taint analysis function to the script engine on the basis of the forced propagation rule.
